(19) United States
(12) Patent Application Publication
(10) Pub. No.: US 2013/0227238 A1
(43) Pub. Date: Aug. 29, 2013

(54) DEVICE AND METHOD FOR A TIME AND SPACE PARTITIONED BASED OPERATING SYSTEM ON A MULTI-CORE PROCESSOR

(71) Applicant: Thomas VIJVERBERG, Weilheim (DE)

(72) Inventor: Thomas VIJVERBERG, Weilheim (DE)

(21) Appl. No.: 13/406,939

(22) Filed: Feb. 28, 2012

(51) Int. Cl. G06F 12/02

(52) U.S. Cl. 711/170; 711/E12.002

(57) ABSTRACT

A device and method runs a plurality of user applications. The device includes a multi-core processor where one core is a supervisor core for an operating system. Each remaining core is a partition core for one of the user applications. The operating system and each of the user applications run concurrently. The device includes a memory arrangement including a plurality of memory blocks. Each memory block includes a predetermined, sequential set of sectors so that data for a first user application is stored only on a first set of sectors of a first memory block and data for a second user application is stored only on a second set of sectors of a second memory block. One memory block is associated with only the supervisor core and each of the remaining memory blocks is associated with only a respective partition core.

### BACKGROUND INFORMATION

A multi-core processor is a single computing unit including at least two processors or cores. The cores are units within the single computing unit that read and execute program instructions. The instructions include ordinary computer instructions such as add data, move data, and branch. In a multi-core processor, the multiple cores are configured to run multiple instructions at the same time, thereby increasing an overall speed for programs amenable to parallel computing.

When running multiple instructions concurrently on at least two cores, the multi-core processor must schedule the instructions accordingly. It should be noted that each core may utilize its own scheduler independently of each other. Conventional schedulers often prioritize high importance instructions over low importance instructions. However, conventional schedulers may stagger portions of a first instruction with portions of a second instruction. Furthermore, a memory arrangement of an electronic device including the multi-core processor is required for executing the instructions. However, conventional memory arrangements allow for data to be written to occupy portions of the memory on a first-come first-served basis, thereby leading to portions of data for the first instruction to be staggered with portions of data for the second instruction.

### SUMMARY OF THE INVENTION

The present invention describes a device and method for running a plurality of user applications. The device comprises a multi-core processor including a plurality of cores, at least one core of the plurality of cores being configured as a supervisor core for an operating system of the device, each remaining core of the plurality of cores being configured as a partition core for a respective one of the plurality of user applications, wherein the operating system and each of the plurality of user applications run concurrently. The device further comprises a memory arrangement including a plurality of memory blocks, each memory block of the plurality of memory blocks including a predetermined, sequential set of sectors so that data for a first user application of the plurality of user applications is stored only on a first set of sectors of a first memory block of the plurality of memory blocks and data for a second user application of the plurality of user applications is stored only on a second set of sectors of a second memory block of the plurality of memory blocks, at least one memory block of the plurality of memory blocks being associated with only the supervisor core, each of the remaining memory blocks of the plurality of memory blocks being associated with only a respective partition core.

### BRIEF DESCRIPTION OF THE DRAWINGS

FIG. 1 shows an electronic device utilizing a multi-core processor according to an exemplary embodiment of the present invention.

FIG. 2 shows a method for performing a system call on a multi-core processor according to an exemplary embodiment of the present invention.

### DETAILED DESCRIPTION

The present invention relates to a device and method for running a plurality of user applications comprising (1) a multi-core processor including a plurality of cores, at least one core of the plurality of cores being configured as a supervisor core for an operating system of the device, each remaining core of the plurality of cores being configured as a partition core for a respective one of the plurality of user applications, wherein the operating system and each of the plurality of user applications run concurrently and (2) a memory arrangement including a plurality of memory blocks, each memory block of the plurality of memory blocks including a predetermined, sequential set of sectors so that data for a first user application of the plurality of user applications is stored only on a first set of sectors of a first memory block of the plurality of memory blocks and data for a second user application of the plurality of user applications is stored only on a second set of sectors of a second memory block of the plurality of memory blocks, at least one memory block of the plurality of memory blocks being associated with only the supervisor core, each of the remaining memory blocks of the plurality of memory blocks being associated with only a respective partition core.

The exemplary embodiments may be further understood with reference to the following description of the exemplary embodiments and the related appended drawings, wherein like elements are provided with the same reference numerals. The exemplary embodiments are related to devices and methods for a time and space partitioned based operating system on a multi-core processor. Specifically, the multi-core processor may be configured to operate so that a timing for executing multiple instructions/applications and a spacing for storing data within a memory arrangement are separated to enable an improved operation of the multi-core processor.

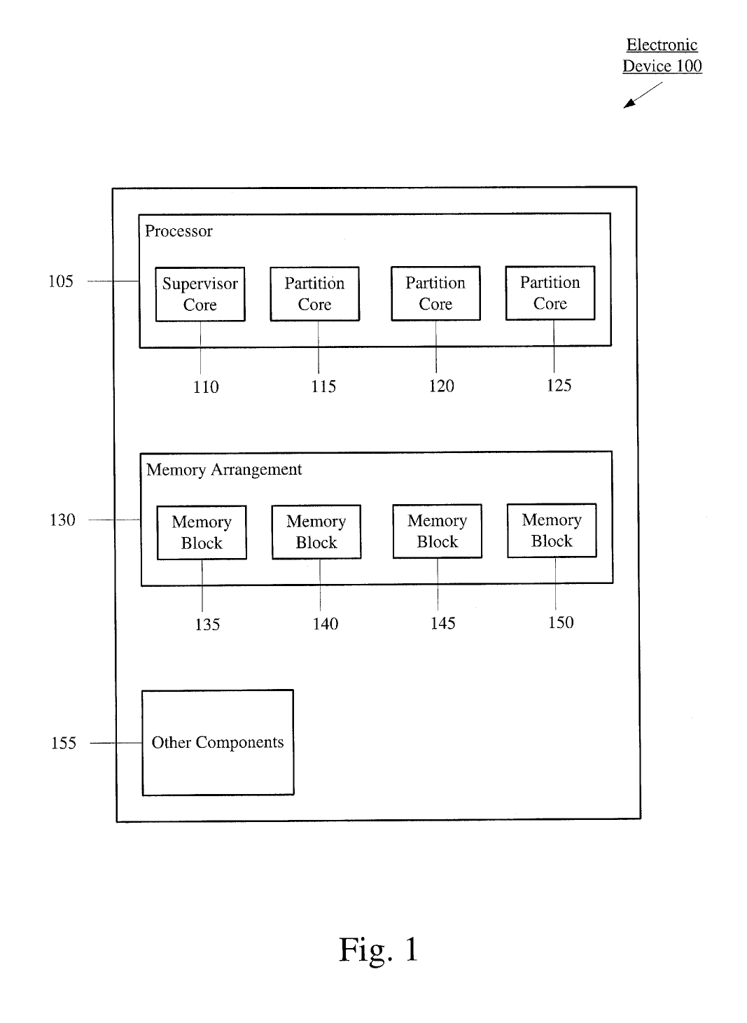

FIG. 1 shows an electronic device 100 utilizing a multi-core processor 105 according to an exemplary embodiment of the present invention. The electronic device 100 may be, for example, a personal computer, a laptop, a tablet, a personal digital assistant, a cellular phone, etc. The multi-core processor 105 may be configured to read and execute computing instructions on a plurality of cores 110, 115, 120, 125. As will be described in further detail below, each core 110, 115, 120, 125 may be configured to process a complete set of instructions, for example, for a user application. Each core 110, 115, 120, 125 may process a single application thereon. Accordingly, as will be described in further detail below, a timing separation may exist between the cores. The electronic device 100 may further include a memory arrangement 130 including a plurality of memory blocks 135, 140, 145, 150. As will be described in further detail below, each memory block 135, 140, 145, 150 may be configured for a respective core only, thereby a space separation may exist. The electronic device 100 may include further components 155 such as a transceiver, an input/output arrangement, an input device, etc.

According to the exemplary embodiments of the present invention, a hardware separation by core is used to achieve a space and time separation in the operating system. Those skilled in the art will understand that a kernel is used to enable communication between an application and devices of the electronic device. The kernel may be responsible for managing the system's resources as well as providing an abstraction layer for the resources. According to the exemplary embodiments, the kernel space applications use a different core(s) than the user space applications. The core 110 may be a core 0 which may represent a supervisor core or a core configured with the operating system of the electronic device 100. According to a preferred embodiment of the present invention, the core 110 may be configured with only the operating system to function as the supervisor core. The core 110 may be configured with the kernel space applications. It should be noted that the core 110 running the operating system is only exemplary. According to a further exemplary embodiment of the present invention, more than one core may be dedicated to running the operating system and the kernel space applications.

Each of the partition cores 115, 120, 125 may be configured for executing a user application and a set of instructions associated therewith. As discussed above, in a preferred embodiment of the present invention, each of the partition cores 115, 120, 125 may process a single user application thereon. The user applications may be any computing process such as a word processor, a browser, a multimedia application, etc.

Through processing user applications on the partition cores 115, 120, 125 while processing the operating system on the supervisor core 110, a time separation may be accomplished. In a conventional multi-core processor, a round robin timing is used. For example, if there are three processes that are to be run, the round robin timing allows for a high importance process to take priority. Therefore, a portion of a first process may be initially run followed by a portion of a second process then with a portion of a third process. This continues in this order until all three processes have completed. As discussed above, such a round robin timing requires the use of a scheduler so that the three processes may be run to completion. However, according to the exemplary embodiments, since each process is run on an individual partition core, there is no requirement for a scheduler as each process may be run concurrently on the different cores. Accordingly, a time separation is achieved.

It should be noted that the use of four cores 110, 115, 120, 125 is only exemplary. Those skilled in the art will understand that conventional multi-core processors may include any number of cores. For example, in a dual-core processor, the single processing unit includes two cores; in a quad-core processor, the single processing unit includes four cores; in a hex-core processor, the single processing unit includes six cores; and in an octa-core processor, the single processing unit includes eight cores. Those skilled in the art will further understand that the exemplary embodiments of the present invention may be applied to any multi-core processor including any number of cores on the single processing unit.

Each user application may perform a system call prior to initiating the application on the respective core. That is, the user application on the respective core may invoke the user application on its own core so that only the single called user application is processed thereon. According to the exemplary embodiments of the present invention, the user application may be processed on the respective core but the system call functionality may be executed as a worker task on one of the cores where the kernel space applications run (i.e., core 110 or the supervisor core). Accordingly, the kernel space applications may monitor the time and space partitioned based operating system and the user space applications.

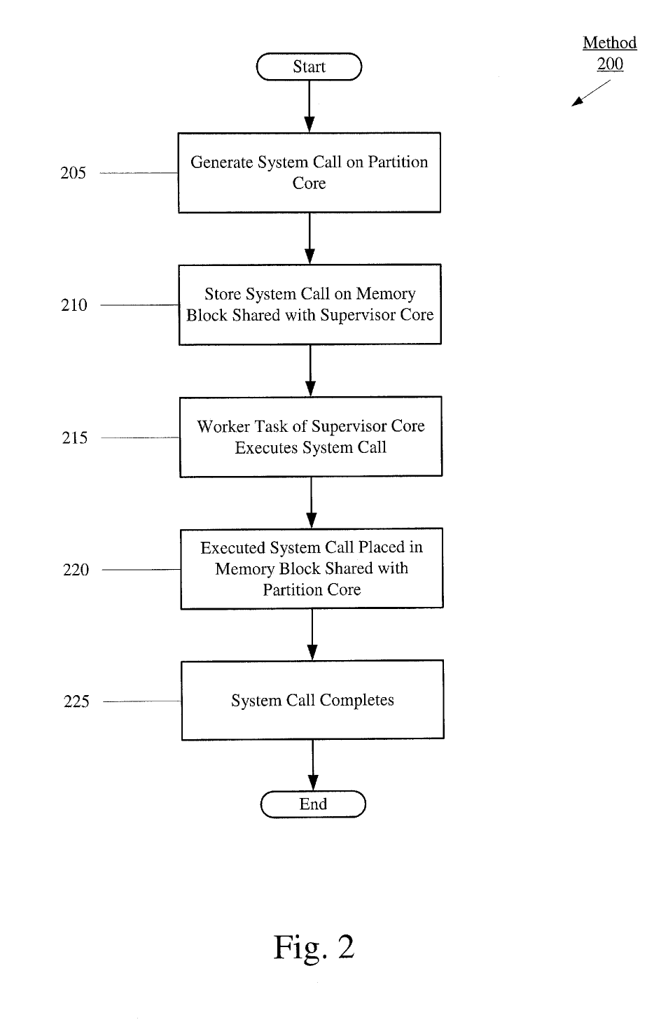

According to the exemplary embodiments of the present invention, a user application running on one of the partition cores 115, 120, 125 makes a system call. That is, the system call argumens are validated. FIG. 2 shows a method 200 for performing a system call on the multi-core processor 100 according to an exemplary embodiment of the present invention. Initially, in step 205, the system call is generated on the partition core. In step 210, the system call made by the partition core may be inserted in an area of the memory arrangement 130 that is shared with the core 110. As discussed above, the memory arrangement 130 includes a plurality of memory blocks 135, 140, 145, 150. In an exemplary embodiment of the present invention, the memory block 135 may be configured for the supervisor core 110; the memory block 140 may be configured for the partition core 115; the memory block 145 may be configured for the partition core 120; and the memory block 150 may be configured for the partition core 125. That is, the associated memory block may be used exclusively for the respective core to which it is assigned. Thus, in a specific example, when the core 115 runs the user application invoking the system call, the system call may be inserted in the memory block 135 which is designated for the supervisor core 110.

In step 215, the worker task of the supervisor core 110 executes the system call. As discussed above, the supervisor core 110 may include the kernel space applications. Furthermore, the supervisor core 110 may include worker tasks associated with the user applications processed on the partition cores 115, 120, 125. Upon the system call being inserted in the memory block 135, a worker task may be initiated on the supervisor core 110 for the user application. The worker task may pick up and execute the system call on the supervisor core 110. In step 220, the executed system call is placed in a memory block shared with the partition core. The result of the system call being executed by the worker task entails the system call being stored in the memory arrangement 130. However, at this stage, the executed system call is placed into the memory block associated with the partition core that is processing the user application. Referring to the above specific example, the executed system call may be placed in the memory block 140 which is designated for the partition core 115. Accordingly, in step 225, the system call completes when the user application on the partition core recognizes the executed system call on the associated memory block.

As discussed above, since the memory arrangement 130 includes a plurality of memory blocks 135, 140, 145, 150, a space partition may be accomplished. Specifically, by separating the memory arrangement 130 so that a specified area is exclusive to a core allows for the memory blocks 135, 140, 145, 150 to not include any potential staggering of data from different cores. According to an exemplary embodiment of the present invention, the memory arrangement 130 may include a plurality of sectors. The memory blocks 135, 140, 145, 150 may include a predetermined number of sectors that are sequential. For example, if the memory arrangement 130 includes 400 sectors, the first 100 sectors may be assigned as the memory block 135; the second 100 sectors may be assigned as the memory block 140; the third 100 sectors may be assigned as the memory block 145; and the fourth 100 sectors may be assigned as the memory block 150. In this manner, the cores 110, 115, 120, 125 may perform respective functionalities/instructions/applications without an inadvertent interruption, especially from data related to a first core being retrieved from within a block of stored data for a second core. Therefore, in a conventional memory arrangement for a multi-core processor, if a process breaks, there is a possibility that the other processes being run may be affected. With the space separation according to the exemplary embodiments of the present invention, if a process breaks, there is no effect on the other concurrently running processes as the data related thereto is separated from the data of the process that may have broken.

It should be noted that the memory blocks 135, 140, 145, 150 may be divided into a variety of different ways. In a first example, the memory blocks 135, 140, 145, 150 may be evenly distributed such as each block occupying 64 MB on a 256 MB memory chip. In a second example, the memory blocks 135, 140, 145, 150 may be distributed unevenly so that cores that utilize require more data will have access to a memory block that is larger to accommodate the additional data. It should again be noted that the distribution remains as predetermined, sequential set of sectors on the memory arrangement 130.

The exemplary embodiments of the present invention provide a multi-core processor system in which a time and a space separation are achieved for an improved operation of the multi-core processor. The multi-core processor may include a plurality of cores of which at least one core is assigned as a supervisor core configured for the operating system and the kernel applications. The other cores may be assigned as partition cores configured for processing a single user application thereon. In this manner, a time separation may be achieved through the processes being run concurrently on different cores without any scheduling conflicts. The memory arrangement of the system may also be configured in a manner to provide the space separation. Specifically, the memory arrangement may be segmented so that areas are designated for a particular core. That is, a portion of the memory is used by only a single core. In this manner, a space separation may be achieved through the data related to applications being separated from data of other applications on the memory arrangement.

To further achieve the time and space separation for the multi-core processor, a system call functionality may be performed for the user application being processed on a particular core. The system call functionality operates to assign and function with the supervisor core and the memory arrangement in a manner to allow the time and space separation to be maintained during the operation of the user application.

The exemplary embodiments of the present invention may be configured for a variety of different uses. For example, in the avionics field, a DO178B standard is used in which five levels of safety are described. In a first level A, a system malfunction results in a catastrophic event while in a fifth level E, a system malfunction results in a negligible event. However, by utilizing the exemplary embodiments of the present invention and the resultant time and space separation of the multi-core processor, a computing system for an airplane may allow for any process to run concurrently without affecting other processes, regardless of the level of safety. Furthermore, should a process fail, other processes may continue to run, in particular the highest level of safety ones.

Those skilled in the art will understand that the above-described exemplary embodiments may be implemented in any number of manners, including, as a separate software module, as a combination of hardware and software, etc. For example, the operating of the multi-core processor to achieve the time and space separation may be part of a program containing lines of code that, when compiled, may be executed on the processor.

It will be apparent to those skilled in the art that various modifications may be made in the present invention, without departing from the spirit or the scope of the invention. Thus, it is intended that the present invention cover modifications and variations of this invention provided they come within the scope of the appended claimed and their equivalents.

What is claimed is:

1. A device for running a plurality of user applications, comprising:
a multi-core processor including a plurality of cores, at least one core of the plurality of cores being configured as a supervisor core for an operating system of the device, each remaining core of the plurality of cores being configured as a partition core for a respective one of the plurality of user applications, wherein the operating system and each of the plurality of user applications run concurrently; and
a memory arrangement including a plurality of memory blocks, each memory block of the plurality of memory blocks including a predetermined, sequential set of sectors so that data for a first user application of the plurality of user applications is stored only on a first set of sectors of a first memory block of the plurality of memory blocks and data for a second user application of the plurality of user applications is stored only on a second set of sectors of a second memory block of the plurality of memory blocks, at least one memory block of the plurality of memory blocks being associated with only the supervisor core, each of the remaining memory blocks of the plurality of memory blocks being associated with only a respective partition core.

2. The device of claim 1, wherein the supervisor core is assigned to only one core of the plurality of cores.

3. The device of claim 1, wherein the supervisor core is configured with kernel space applications.

4. The device of claim 1, wherein the first memory block has an equal amount of space of a total space of the memory arrangement to the second memory block.

5. The device of claim 1, wherein the first memory block has a greater amount of space of a total space of the memory arrangement than the second memory block.

6. The device of claim 1, wherein one of the partition cores is capable of invoking a system call for the respective user application processed thereon.

7. The device of claim 6, wherein the system call is stored on the at least one memory block of the plurality of memory blocks associated with only the supervisor core.

8. The device of claim 7, wherein the supervisor core is configured with worker task functionalities, each worker task functionality assigned to a respective user application of the plurality of user applications, the respective worker task functionality executing the system call.

9. The device of claim 8, wherein the executed system call is stored on the memory block of the plurality of memory blocks associated with the respective partition core.

10. The device of claim 1, wherein the user application is processed only on the respective partition core.

11. A method, comprising:
running an operating system and a plurality of user applications concurrently on a multi-core processor including a plurality of cores, at least one core of the plurality of cores being configured as a supervisor core for the operating system, each remaining core of the plurality of cores being configured as a partition core for a respective one of the user applications; and
allocating a plurality of memory blocks of a memory arrangement, each memory block of the plurality of memory blocks including a predetermined, sequential set of sectors so that data for a first user application of the plurality of user applications is stored only on a first set of sectors of a first memory block of the plurality of memory blocks and data for a second user application of the plurality of user applications is stored only on a second set of sectors of a second memory block of the plurality of memory blocks, at least one memory block of the plurality of memory blocks being associated with only the supervisor core, each of the remaining memory blocks of the plurality of memory blocks being associated with only a respective partition core.

12. The method of claim 11, wherein the supervisor core is assigned to only one core of the plurality of cores.

13. The method of claim 11, wherein the supervisor core is configured with kernel space applications.

14. The method of claim 11, wherein the first memory block has an equal amount of space of a total space of the memory arrangement to the second memory block.

15. The method of claim 11, wherein the first memory block has a greater amount of space of a total space of the memory arrangement than the second memory block.

16. The method of claim 11, further comprising:
invoking a system call by one of the partition cores for the respective user application processed thereon.

17. The method of claim 16, further comprising:
storing the system call on the at least one memory block associated with only the supervisor core.

18. The method of claim 17, wherein the supervisor core is configured with worker task functionalities, each worker task functionality assigned to a respective user application, the respective worker task functionality executing the system call.

19. The method of claim 18, further comprising:
storing the executed system call on the memory block associated with the respective partition core.

20. A device, comprising:
a processing means for running an operating system and a plurality of user applications, the processing means including a plurality of cores, at least one core of the plurality of cores being configured as a supervisor core for the operating system of the device, each remaining core of the plurality of cores being configured as a partition core for a respective one of the plurality of user applications, wherein the operating system and each of the plurality of user applications run concurrently; and
a storage means for storing data associated with the plurality of user applications, the storage means including a plurality of memory blocks, each memory block of the plurality of memory blocks including a predetermined, sequential set of sectors so that data for a first user application of the plurality of user applications is stored only on a first set of sectors of a first memory block of the plurality of memory blocks and data for a second user application of the plurality of user applications is stored only on a second set of sectors of a second memory block of the plurality of memory blocks, at least one memory block of the plurality of memory blocks being associated with only the supervisor core, each of the remaining memory blocks of the plurality of memory blocks being associated with only a respective partition core.
